(19) United States
(12) Patent Application Publication
(10) Pub. No.: US 2010/0126137 A1
(43) Pub. Date: May 27, 2010

(54) Combustion Installation

(76) Inventor: Stellan Hamrin, Kungsor (SE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/523,604

(22) PCT Filed: Jan. 16, 2008
(86) PCT No.: PCT/EP2008/050421

§ 371 Date: Jan. 20, 2010

(30) Foreign Application Priority Data
Jan. 19, 2007 (SE) 0700123-3

(51) Int. Cl. F02C 3/20; F02C 7/22; F02C 7/08

(52) U.S. Cl. 60/39.461; 60/740; 60/785

(57) ABSTRACT

A combustion installation including a combustion device with a combustion space for combustion of a fuel and an oxygen-containing gas to a combustion gas in the combustion space and a membrane device is described. The membrane device is arranged for the flow of air, past a membrane in a second compartment of the membrane device, to be in the same direction as the flow of combustion gases, past the membrane in a first compartment of the membrane device.

### CROSS REFERENCE TO RELATED APPLICATIONS

This application is the US National Stage of International Application No. PCT/EP2008/050421 filed Jan. 16, 2008, and claims the benefit thereof. The International application claims the benefits of Swedish Patent Application No. 0700123-3 SE filed Jan. 19, 2007; both of the applications are incorporated by reference herein in their entirety.

### FIELD OF INVENTION

The present invention relates to a combustion installation comprising a combustion device, a gas turbine and a membrane device arranged to separate oxygen from a gas mixture.

### BACKGROUND OF INVENTION

There are different demands and desires for decreasing unwanted exhausts from combustion installations. Thus, it is for instance desirable to reduce exhausts from combustion installations, for example exhausts of nitrogen oxides as far as possible.

There is a world wide interest in decreasing exhausts of carbon dioxide that is produced during combustion. It is possible to separate carbon dioxide from a combustion gas but as the concentration of carbon dioxide usually is low and as the combustion gas comprises other components, such as oxygen and nitrogen, it is complicated to separate the carbon dioxide from the combustion gas.

The separation of carbon dioxide from the combustion gas may be facilitated by performing the combustion in another medium than air, from which medium carbon dioxide more easily can be separated. If air is not used as combustion medium it is necessary to add oxygen to the medium. It is, however, expensive to produce oxygen in the necessary volumes. One possibility for producing oxygen is to use a suitable membrane device which is arranged to separate oxygen from a gas mixture, which gas mixture usually is air. Such membrane devices are often called “solid electrolyte membrane (SEM)”.

Such membrane devices are described in U.S. Pat. No. 5,118,395. This document describes two types of such SEM. The first type of SEM comprises a membrane, which is arranged between two electrodes to which a voltage source may be connected in order to apply a voltage over the membrane. The second type of SEM is called “mixed conducting membrane (MCM)”. This type of membrane device comprises an MCM material as a membrane and works without a voltage being applied. Such a membrane works through the partial pressure of oxygen being lower on the side of the membrane to which oxygen is transported. Oxygen ions are here directed in the first direction through the membrane and electrons are directed back through the membrane in the opposite direction. The document describes use of such membrane devices on the output side from a gas turbine to extract oxygen from the exhaust gases of the turbine. In this context a third type of membrane should be mentioned, namely a membrane of fuel cell material. Such a membrane directs oxygen ions in a first direction while electrons are led back via an external conduit circuit.

Also EP-A-658,367 describes different types of SEM. This document describes different combustion installations with a membrane device from which oxygen is extracted. The oxygen-enriched gas which is produced in the membrane device is led to one or more combustion devices and combustion gases from the combustion devices are used to drive a gas turbine.

The Norwegian published patent application NO-A-972,631 describes the use of an MCM in combustion processes. According to the described processes compressed air is directed to an MCM reactor. The MCM reactor comprises a membrane device, which separates oxygen from the air. The heated air from which oxygen has been separated is led away via a heat exchanger. The separated oxygen is used for combustion. The combustion gases comprise mainly water vapour and carbon dioxide. The water vapour may be condensed which makes it possible to separate the carbon monoxide. As nitrogen does not take part in the combustion process the exhaust of unwanted nitrogen oxides is avoided.

In the PCT application WO 01/92703 a combustion installation is described in which fuel is combusted without nitrogen. The first flow of compressed air from the compressor passes an MCM reactor in which the compressed air is heated by a second flow of combustion gases and oxygen from the air is transported over to the other flow of combustion gases. The combustion gases which have been cooled off and to which oxygen has been added are led back to a combustion chamber. In the combustion chamber fuel is added which is combusted with the oxygen, which was added from the air in the MCM reactor. The flow of air in the MCM reactor is counter-current to the flow of combustion gases.

In order to achieve a high efficiency of the combustion installation the transfer of oxygen through the membrane has to be efficient. The efficiency in membranes is dependent on the temperature. In most cases the efficiency of membranes increases with increasing temperature up to a maximum temperature at which the membrane starts to be destroyed. In prior art combustion installations the temperature of the membrane is far from optimum along a major part of the membrane.

Another problem with the prior art combustion installations is that the temperature of the gas leaving the membrane device is too low to allow the mixture of this gas and fuel to ignite spontaneously in the combustion chamber. Thus, a catalytic burner is usually arranged between the membrane device and the combustion chamber in combustion installations of the prior art.

### SUMMARY OF INVENTION

An object of the present invention is to provide an alternative combustion installation with a membrane device.

Another object of the present invention is to provide a combustion installation with a membrane device which provides for a more optimum temperature in the membrane device.

Still another object of the present invention is to provide a combustion installation in which fuel is combusted with oxygen without nitrogen and, in which fuel is more easily ignited compared with combustion installations according to the prior art.

These objects are achieved with a combustion installation according to the independent claim.

Further advantages of the invention are achieved with the features of the dependent claims.

A combustion installation according to the present invention comprises a combustion device with a combustion space, having an inlet and an outlet, for combustion of a fuel and an oxygen-containing gas to a combustion gas in the combustion space. The combustion installation also comprises a membrane device comprising a first compartment, having an inlet and an outlet, for the flow of combustion gases and a second compartment for the flow of air. The first compartment and the second compartment are separated by a membrane allowing oxygen to pass from the air in the second compartment to the combustion gases in the first compartment for production of the oxygen-containing gas. The inlet and the outlet of the combustion space is connected to the outlet and the inlet of the first compartment of the membrane device, respectively. The combustion installation is characterised in that the membrane is arranged for the flow of air, past the membrane in the second compartment of the membrane device, to be in the same direction as the flow of combustion gases, past the membrane in the first compartment of the membrane device.

A combustion installation according to the present invention provides a more compact design of the combustion installation than combustion installations according to the prior art. Furthermore, a combustion installation according to the present invention provides for a more optimal temperature on the membrane. The flow of air and the flow of combustion gas are in the same direction past the membrane. Thus, the temperature of the combustion gas decreases downstream the membrane device while the temperature of the air increases downstream the membrane device. This makes it possible to achieve an essentially constant temperature over the entire surface of the membrane. Furthermore, the temperature of the oxygen containing air leaving the membrane device is considerably higher than the temperature of the oxygen containing air leaving the membrane in prior art combustion installations. The higher temperature makes it possibly for the mixture of oxygen containing gas and fuel to ignite spontaneously.

It is preferable to have the temperature of the membrane in the range of 600-1100° C. and preferably in the range of 850-900° C. In these ranges of temperatures the transport of oxygen ions through the membrane is high.

The combustion device of the combustion installation may comprise a heating space arranged for heat to be transferred from the combustion space to the heating space. By arranging the combustion installation in this way it becomes possible to take advantage of the heat produced in the combustion space.

The combustion device of the combustion installation may be arranged in such a way that the combustion and the heating space are separated by a wall. The combustion device is then in principle also a heat exchanger. The wall is preferably a wall with a high heat conductivity. The wall may be a metal wall but may also be of another material suitable for the transportation of heat between the combustion space and the heating space.

The heating space may comprise an inlet and an outlet, wherein the inlet of the heating space is connected to the outlet of the second compartment of the membrane device. It is also possible to have the heating space integrated with the second compartment of the membrane device.

The combustion installation may comprise a fuel nozzle for injection of fuel into the combustion space of the combustion device. With a nozzle it is made possible to direct the fuel into the combustion chamber.

The fuel nozzle may be arranged to inject fuel or a mixture of fuel and a carrying gas into the combustion space of the combustion device in order to maintain a flow of gas through the combustion space. The fuel nozzle may be arranged as a part of an injector device. It is not necessary that the fuel is injected directed straight towards the outlet of the combustion space but it is sufficient that a component of the velocity of the fuel is directed towards the outlet of the combustion device to provide a flow of gas through the combustion space.

The combustion installation may comprise a low temperature co-current flow heat exchanger comprising a first compartment and a second compartment, and being arranged upstream the membrane device.

The combustion installation may be arranged in such a way that the outlet of the combustion space is connected to the inlet of the first compartment of the membrane device via the first compartment of the low temperature heat exchanger. There are of course other ways of arranging the low temperature heat exchanger.

The second compartment of the low temperature heat exchanger may comprise an inlet and an outlet, wherein the outlet of the second compartment of the low temperature heat exchanger is connected to the inlet of the membrane device. There might be arranged other components between the low temperature heat exchanger and the membrane device.

It is also possible to arrange the low temperature heat exchanger together with the membrane device in a common unit. This provides for a more compact combustion installation.

The combustion installation may comprise a high temperature co-current flow heat exchanger comprising a first compartment and a second compartment, and being arranged downstream the membrane device. Such a high temperature heat exchanger may be arranged together with the combustion device in a common unit.

The combustion installation may be arranged to comprise a bleed outlet connected to the outlet of the combustion space. As the amount of materia in the combustion space is increased by the fuel being injected through the nozzle it is necessary to dispose with some of the materia in the combustion gas in order to keep a constant pressure in the combustion device. Such disposal is provided for in an effective way by a bleed outlet arranged connected to the outlet of the combustion space. It is possible to have a common pipe from the outlet of the combustion device to the inlet of the membrane device and to the bleed outlet. It is also possible to have separate pipes to the bleed outlet and the membrane device.

The combustion installation may comprise a bleed heat exchanger with a first compartment and a second compartment wherein the first compartment is connected to the outlet of the combustion space and the second compartment is connected to the inlet of the second compartment of the low temperature heat exchanger. By arranging such a bleed heat exchanger the heat of the disposed combustion gas is used to heat the air before it reaches the membrane device.

The bleed heat exchanger may be arranged for the flow of air through the second compartment of the bleed heat exchanger to be counter-current to the flow of the combustion gas in the first compartment of the bleed heat exchanger. This may be advantageous as it is more easily implemented together with the membrane device according to the invention. It is however also possible to arrange the bleed heat exchanger so that the flow of air through the second compartment is in the same direction as the flow of combustion gas through the first compartment of the bleed heat exchanger.

The combustion installation may comprise a gas expander, such as, e.g., a turbine, connected to the outlet of the heating space of the combustion device. The gas turbine is driven by the air that has been heated in the heating space of the combustion device.

The combustion installation may comprise a compressor arranged for compressing and directing air into the inlet of the second compartment of the membrane device. There are alternative ways of providing air to the second compartment of the membrane device. However, by arranging a compressor for compressing and directing air into the inlet of the second compartment of the membrane device the air may be provided at a higher pressure and more oxygen may thus be directed through the membrane.

### BRIEF DESCRIPTION OF THE DRAWINGS

In the following preferred embodiments of the invention will be described with reference to the appended drawings.

FIG. 1 shows schematically a combustion installation according to an embodiment of the present invention.

FIG. 2 shows schematically a combustion installation according to an alternative embodiment of the present invention.

### DETAILED DESCRIPTION OF INVENTION

In the following description of preferred embodiments of the invention similar features will be designated with the same reference numerals in the different drawings.

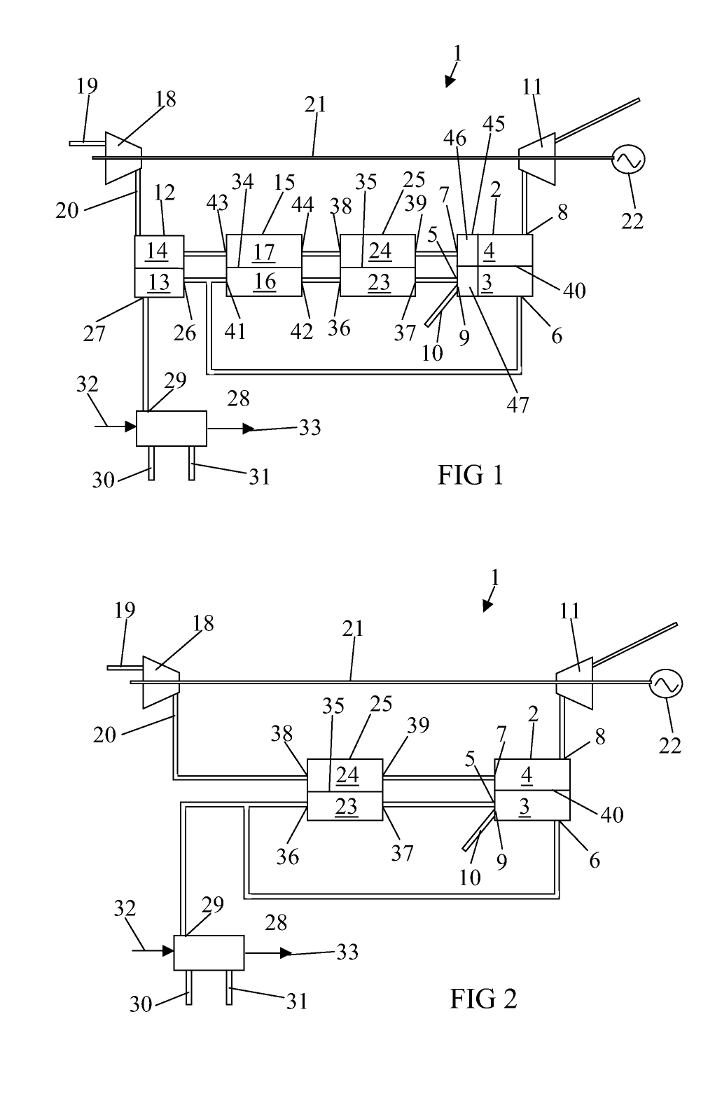

A combustion installation 1 according to a first embodiment of the present invention is schematically shown in cross section in FIG. 1. The combustion installation 1 comprises a combustion device 2 having a combustion space 3, for combustion of a fuel and an oxygen containing gas into a combustion gas, and a heating space 4 for heating of air. The combustion space 3 and the heating space 4 are separated by a wall 40 allowing heat to be transported between the spaces 3, 4. The combustion device 2 also functions as a heat exchanger. The combustion space 3 of the combustion device 2 has an inlet 5 and an outlet 6. The heating space of the combustion device has correspondingly an inlet 7 and an outlet 8. A fuel nozzle 9 is arranged in the combustion space and may be arranged as a part of an injector device and is arranged to inject fuel into the combustion space in the direction towards the outlet 6 of the combustion space. A fuel line 10 is connected to the fuel nozzle and to a fuel tank which is not shown in the figure. The combustion device 2 also comprises a high temperature co-current flow heat exchanger 45 comprising a first compartment 46 and a second compartment 47. In FIG. 1 the high temperature heat exchanger forms a unit together with the combustion device (2). The outlet 8 of the heating space is connected to an expander in the form of a gas turbine 11. The gas turbine is driven by air which is heated in the heating space 4 of the combustion device 2.

The combustion installation 1 further comprises a bleed heat exchanger 12 comprising a first compartment 13 and a second compartment 14 and a low temperature heat exchanger 15 comprising a first compartment 16 and a second compartment 17. The first compartment 16 of the low temperature heat exchanger 15 comprises an inlet 41 and an outlet 42. The second compartment 17 of the low temperature heat exchanger 15 comprises an inlet 43 and an outlet 44. The first compartment 16 and the second compartment 17 of the low temperature heat exchanger 15 are divided by a wall 34 allowing heat to be transported between the compartments 16, 17. The outlet 6 of the combustion device is connected to the first compartment 13 of the bleed heat exchanger 12 and to the first compartment 16 of the low temperature heat exchanger. The combustion installation 1 also comprises a compressor 18 with an air inlet 19 and an air outlet 20. The air outlet 20 is connected to the first compartment 13 of the bleed heat exchanger 12 to provide for the transport of compressed air into the bleed heat exchanger 12. The compressor 18 and the gas turbine 11 are arranged coupled to the same axle 20 so that the compressor 18 is driven by the gas turbine 11. Also arranged coupled to the axle 21 is a generator 22.

The combustion installation 1 also comprises a membrane device 25 which is arranged between the low temperature heat exchanger 15 and the combustion device 2. The membrane device comprises a first compartment 23 with an inlet 36 and an outlet 37, and a second compartment 24 with an inlet 38 and an outlet 39. The first compartment 23 of the membrane device 25 is connected to the first compartment 16 of the low temperature heat exchanger 15 and to the combustion space 3 of the combustion device 2. The second compartment 24 of the membrane device 25 is connected to the second compartment 17 of the low temperature heat exchanger and to the heating space 4 of the combustion device 2. The compartments 23, 24 of the membrane device are divided by a membrane 35 which is arranged to allow oxygen to pass the membrane 35. The membrane 35 may be of any type known in the art which allows oxygen to pass.

The combustion installation also comprises a cooler 28 comprising an inlet 29, a water outlet 30, a carbon dioxide outlet 31, a cooling water inlet 32 and a cooling water outlet 33. The first compartment 13 of the bleed heat exchanger 12 comprises an inlet 26 and an outlet 27, wherein the inlet 26 of the bleed heat exchanger 12 is connected to the outlet 6 of the combustion space 3 of the combustion device 2 as mentioned above. The outlet 27 of the bleed heat exchanger 12 is connected to the inlet 29 of the cooler 28.

During operation air from the air inlet 19 is compressed in the compressor 18 and compressed air 20 is transported into the second compartment 14 of the bleed heat exchanger 12, in which the compressed air is heated by the combustion gases passing the first compartment 13 of the bleed heat exchanger 12. In the bleed heat exchanger the air is heated from approximately 400-500° C. to approximately 500-600° C. The heated compressed air continues through the second compartment 17 of the low temperature heat exchanger 15 where it is further heated to approximately 800-900° C. by the combustion gases passing the first compartment 16 of the low temperature heat exchanger 15. As the flow of combustion gases in the first compartment 16 of the low temperature heat exchanger 15 is in the same direction as the flow of air in the second compartment 17 of the low temperature heat exchanger 15 the temperature difference between the compartments 16, 17, decreases downstream the low temperature heat exchanger 15.

After having passed the low temperature heat exchanger the air passes the membrane device 25 where oxygen passes from the air in the second compartment 24 to the combustion gas in the first compartment 23 so that the oxygen containing gas is created. At the same time the air is further heated by the combustion gases in the first compartment of the membrane device 25 to approximately 900-1000° C. The air from the second compartment 24 of the membrane device 25 is then directed into the heating space 4 of the combustion device 2 where the air is further heated to approximately 1200-1300° C. The heated air is then finally directed through the gas turbine 11 for driving the rotation of the gas turbine 11. The electric generator 22 and the compressor 18 are also driven by the gas turbine 11.

The oxygen containing gas that leaves the first compartment 23 of the membrane device 25 has been cooled to approximately 900-1000° C. The oxygen containing gas is directed into the combustion space 3 of the combustion device 2 together with fuel from the fuel line 10 which is injected into the combustion space 3 of the combustion device through the fuel nozzle 9. The injection of the fuel into the combustion space 3 drives the flow of the combustion gases out of the combustion space. The combustion gas reaches a temperature of approximately 1300-1400° C. before leaving the combustion space 3 through the outlet 6 of the combustion space 3. A minor part of the combustion gases is directed through the bleed heat exchanger 12 while the major part of the combustion gas is directed through the first compartment 16 of the low temperature heat exchanger 15 where the combustion gas heats the air passing the second compartment 17 of the low temperature heat exchanger 15. The combustion gas leaving the low temperature heat exchanger has a temperature of approximately 1000-1100° C. The combustion gas from the first compartment 16 of the low temperature heat exchanger 15 then enters the membrane device 25 in which it receives oxygen from the air in the second compartment of the membrane device 25 so that the oxygen containing gas is formed.

The temperature of the membrane 35 is approximately the mean value of the temperature of the air in the second compartment 24 and the temperature of the combustion gas in the first compartment 23. This means that, under assumption that the flow of air and the flow of combustion gas are equal in size, the temperature of the membrane is approximately 900-1000° C. which is an optimal temperature interval for many membranes known in the art.

It is of course possible to adjust the temperatures mentioned above by adjusting the size of the different flows and by adjusting the length of the heat exchangers. Temperatures different from the temperatures mentioned above may be desired when a membrane, having a maximum oxygen permeability at a different temperature interval, is used.

The part of the combustion gas that leaves through the bleed heat exchanger 12 is directed into the cooler 28 through the inlet 29 of the cooler. In the cooler 28 the combustion gas is cooled by cooling water passing from the cooling water inlet 32 to the cooling water outlet 33. By cooling the combustion gas the water in the combustion gas is condensed while the carbon dioxide remains vaporised. Thus, the combustion gas may be separated into water leaving the cooler through the water outlet 30 and carbon dioxide leaving the cooler through the carbon dioxide outlet 31. The carbon dioxide may then be taken care of separately in any desired way.

In FIG. 2 a combustion installation 1 according to a second embodiment of the present invention is described. Only the differences between the first embodiment and the second embodiment will be described. In the embodiment shown in FIG. 2 the outlet 20 of the compressor 18 is directly coupled to the second compartment 24 of the membrane device 25. Furthermore, the outlet 6 of the combustion space 3 of the combustion device 2 is directly connected to the first compartment 23 of the membrane device 25 as well as directly to the inlet 29 of the cooler 28.

The combustion installation 1 according to this second embodiment of the present invention has a smaller number of parts than the combustion installation according to the first embodiment of the present invention.

In operation the combustion installation 1 according to this second embodiment functions in essentially the same way as the combustion installation 1 according to the first embodiment, with the exception that the compressed air from the outlet 20 of the compressor 18 is directed directly to the second compartment 24 of the membrane device 25 and that the combustion gas from the combustion space of the combustion device is directed directly into the first compartment 23 of the membrane device 25. This leads to a somewhat lower mean temperature of the membrane if the size of the flows are the same as in the first embodiment of the invention described above.

The described embodiments may of course be amended in many ways without departing from the scope of the present invention which is limited only by the appended claims.

It is not necessary to have the gas turbine 11 to drive the compressor as described above, but the compressor may be driven in any other way known to persons skilled in the art.

It is possible to have the high temperature heat exchanger 45 as a separate part.

1.-17. (canceled)

18. A combustion installation, comprising:
a combustion device with a combustion space, the combustion space including an inlet and an outlet, for combustion of a fuel and an oxygen-containing gas to a combustion gas in the combustion space; and
a membrane device including
a first compartment with an inlet and an outlet for the flow of combustion gases,
a second compartment for the flow of air,
a membrane, wherein the first compartment and the second compartment are separated by the membrane allowing oxygen to pass from the air in the second compartment to the combustion gases in the first compartment for production of the oxygen-containing gas,
wherein the inlet and the outlet of the combustion space is connected to the outlet and the inlet of the first compartment of the membrane device, respectively, and
wherein the membrane device is arranged for the flow of air, past the membrane in the second compartment of the membrane device, to be in a same direction as the flow of combustion gases, past the membrane in the first compartment of the membrane device.

19. The combustion installation as claimed in claim 18, wherein the combustion device further comprises a heating space arranged for heat to be transferred from the combustion space to the heating space.

20. The combustion installation as claimed in claim 19, wherein the combustion space and the heating space are separated by a wall.

21. The combustion installation as claimed in claim 19, wherein the heating space comprises an inlet and an outlet, and wherein the inlet of the heating space is connected to the outlet of the second compartment of the membrane device.

22. The combustion installation as claimed in claim 20, wherein the heating space comprises an inlet and an outlet, and wherein the inlet of the heating space is connected to the outlet of the second compartment of the membrane device.

23. The combustion installation as claimed in claim 18, further comprising:
a fuel nozzle for injection of fuel into the combustion space of the combustion device.

24. The combustion installation as claimed in claim 23, wherein the fuel nozzle is arranged as a part of an injector device arranged to inject fuel into the combustion space of the combustion device.

25. The combustion installation as claimed in claim 18, further comprising:
a low temperature co-current flow heat exchanger including a first compartment and a second compartment and being arranged upstream the membrane device.

26. The combustion installation as claimed in claim 18, further comprising:
a high temperature co-current flow heat exchanger including a first compartment and a second compartment and being arranged downstream the membrane device.

27. The combustion installation as claimed in claim 25, wherein the outlet of the combustion space is connected to the inlet of the first compartment of the membrane device via the first compartment of the low temperature heat exchanger.

28. The combustion installation as claimed in claim 27, wherein the second compartment of the low temperature heat exchanger comprises an inlet and an outlet, and wherein the outlet of the second compartment of the low temperature heat exchanger is connected to the inlet of the second compartment of the membrane device.

29. The combustion installation as claimed in claim 25, wherein the low temperature heat exchanger is arranged together with the membrane device in a common unit.

30. The combustion installation as claimed in claim 27, wherein the low temperature heat exchanger is arranged together with the membrane device in a common unit.

31. The combustion installation as claimed in claim 28, wherein the low temperature heat exchanger is arranged together with the membrane device in a common unit.

32. The combustion installation as claimed claim 26, wherein the high temperature heat exchanger is arranged together with the combustion device in a common unit.

33. The combustion installation as claimed in claim 18, further comprising:
a bleed outlet connected to the outlet of the combustion space.

34. The combustion installation as claimed in claim 18, further comprising:
a bleed heat exchanger with a first compartment and a second compartment, the first compartment being connected to the outlet of the combustion space and the second compartment being connected to the inlet of the second compartment of the low temperature heat exchanger.

35. The combustion installation as claimed in claim 34, wherein the bleed heat exchanger is arranged for the flow of air through the second compartment of the bleed heat exchanger to be counter-current to the flow of the combustion gas in the first compartment of the bleed heat exchanger.

36. The combustion installation as claimed in claim 18, further comprising:
an expander connected to the outlet of the heating space of the combustion device.

37. The combustion installation as claimed in claim 18, further comprising:
a compressor arranged for compressing and directing air into the inlet of the second compartment of the membrane device.
